(19) United States
(12) Patent Application Publication
(10) Pub. No.: US 2005/0282562 A1
(43) Pub. Date: Dec. 22, 2005

(54) Method and system for forming and transmitting/receiving neighbor base station information in a broadband wireless access communication system

(75) Inventors: Sung-Jin Lee, Suwon-si (KR); Chang-Hoi Koo, Seongnam-si (KR); Jung-Je Son, Seongnam-si (KR); Hyoung-Kyu Lim, Seoul (KR); Hyun-Jeong Kang, Seoul (KR); So-Hyun Kim, Suwon-si (KR); Yeong-Moon Son, Anyang-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO. LTD., Gyeonggi-do (KR)

(21) Appl. No.: 11/155,220

(22) Filed: Jun. 17, 2005

(30) Foreign Application Priority Data
Jun. 18, 2004 (KR) 2004-45759

(51) Int. Cl. H04Q 7/20

(52) U.S. Cl. 455/458; 455/440

(57) ABSTRACT

In a broadband wireless access communication system which includes a mobile station, a serving base station and neighbor base stations located adjacent to the serving base station, the serving base station collects the information of the neighbor base stations, determines if the collected information of the neighbor base stations matches the information of the serving base station, sets up predetermined groups by classifying the neighbor base stations according to a result of the determination, and broadcasts a predetermined message including information of the setup groups, and the mobile station receives the predetermined message broadcasted, confirms the information of the neighbor base stations included in the received message, and performs location information update in accordance with the confirmed information.

### PRIORITY

This application claims priority to an application entitled “Method And System For Forming And Transmitting/Receiving Neighbor Base Station Information In A Broadband Wireless Access Communication System” filed in the Korean Industrial Property Office on Jun. 18, 2004 and assigned Serial No. 2004-45759, the contents of which are hereby incorporated by reference.

### BACKGROUND OF THE INVENTION

1. Field of the Invention

The present invention relates to a Broadband Wireless Access (BWA) communication system, and more particularly to a method and system for forming and transmitting/receiving information of neighbor base stations periodically broadcast by a serving base station.

2. Description of the Related Art

A 4^{th} generation (4G) communication system is the next generation communication system. Research has been actively pursued to provide users with 4G communications having various improved quality of services (QoS) at high speed. Research on the current 4G communication systems has been focused on ensuring mobility and QoS in BWA communication system, such as wireless Local Area Network (LAN) systems and wireless Metropolitan Area Network (MAN) systems which are capable of supporting relatively high transmission speeds. Representing such new type communication systems, an Institute of Electrical and Electronics Engineers (IEEE) 802.16a communication system and an IEEE 802.16e communication system have been developed.

The IEEE 802.16a communication system and an IEEE 802.16e communication system employ an Orthogonal Frequency Division Multiplexing (OFDM) scheme and an Orthogonal Frequency Division Multiple Access (OFDMA) scheme in order to support broadband transmission networking for a physical channel of the wireless MAN system. The IEEE 802.16a communication system is a system for only a single structure in which the Subscriber Station (SS) is in a stationary state. The IEEE 802.16a standard does not recognize the mobility of an SS at all. In contrast, the IEEE 802.16e communication system does reflects the mobility of the SS. An SS having mobility will be referred to as a Mobile Station (MS).

Hereinafter, the structure of the conventional IEEE 802.16e communication system will be described with reference to FIG. 1 which is a block diagram schematically showing the structure of the IEEE 802.16e communication system.

The IEEE 802.16e communication system has a multi-cell structure including a cell 1 100, a cell 2 150, a cell 3 170 and a cell 4 180. Further, the IEEE 802.16e communication system includes a Base Station (BS) 1 110 controlling the cell 1 100, a BS 2 140 controlling the cell 2 150, a BS 3 172 controlling the cell 3 170, a BS 4 182 controlling the cell 4 180, and a plurality of MSs 2 111, 1 113, 8 130, 4 151, 3 153, 6 174, 7 176, and 5 184. The transmission/reception of signals between the BSs 1 110, 2 140, 3 172 and 4 182 and the MSs 111, 113, 130, 151, 153, 174, 176 and 184 is accomplished using an OFDM/OFDMA scheme. Herein, the MS 130 8 from among the MSs 111, 113, 130, 151, 153, 174, 176 and 184 is located in a boundary area (i.e., handover area) between the cell 1 100 and the cell 2 150. Accordingly, it is possible to support the mobility of the MS 8 130 only when the handover for the MS 8 130 is supported. When handover is necessary as the MS 8 130 moves into the cell 2 150 controlled by the BS 2 140 while transmitting/receiving a signal with the BS 1 110 controlling the cell 1 100, the connection setup of the physical layer and the Medium Access Control (MAC) layer for the communication with the BS 110 1 is no longer available for communication with the BS 2 140. Therefore, when the MS 8 130 moves from the cell 1 100 to the cell 2 150, the MS 8 130 must again perform a re-entry process for the connection setup with the BS 2 140 in the same manner as that for the first connection setup with the BS 1 110.

In the IEEE 802.16e communication system as described above, an MS receives pilot signals transmitted from a plurality of BSs. The MS measures Carrier to Interference and Noise Ratio (CINR) of the received pilot signals. Then, the MS selects the BS transmitting the pilot signal, having the largest CINR from among the measured CINRs of the received pilot signals, to become the serving BS (i.e. the BS to which the MS currently belongs). In other words, the MS recognizes the BS transmitting the pilot signal, which can be received in best condition by the MS from among the plurality of BSs, as the serving BS for the MS. After selecting the serving BS, the MS transmits and receives data by receiving downlink frames and uplink frames transmitted from the serving BS.

Dynamic Host Configuration Protocol (DHCP) server 1 190 and DHCP server 2 192 are servers for allocating Internet Protocol (IP) addresses in response to requests from the MSs 111, 113, 130, 151, 153, 174, 176 and 184 connected through the BSs 110, 140, 172 and 182. Hereinafter, DHCP server 1 190 and DHCP server 2 192 will be referred to as simply DHCP 1 190 and DHCP 2 192. In general, the DHCP servers possess different assignable IP addresses, distributed in advance to them due to the finite number of available IP addresses. Referring to FIG. 1, BS 1 110 and BS 3 172 are connected to DHCP 1 190 and BS 2 140 and BS 4 182 are connected to DHCP 2 192. That is, the BSs may be connected to either the same DHCP server or different DHCP servers according to the location of the BSs. Therefore, when MSs are allocated IP addresses from DHCP 1 190 through BS 1 110 and BS 3 172, they are allocated IP addresses from the same DHCP server and the IP addresses allocated to them have the same address system and the same prefix value. In the same manner, DHCP 2 192 allocates IP addresses having the same prefix value to MSs through BS 2 140 and BS 4 182.

Therefore, when MS 1 113 is located within cell 1 100 so that MS 1 113 connects with and is allocated an IP address from DHCP 1 190 through BS 1 110 and when MS 1 113 is located within cell 3 170 so that MS 1 113 connects with and is allocated an IP address from DHCP 1 190 through BS 3 172, the IP addresses allocated in both cases have the same prefix value because they are allocated by the same DHCP 1 190. The MS 1 113 is allocated an IP address having the same prefix value from DHCP 1 190 when it is located in either cell 1 100 or cell 3 170. Even after moving into cell 3 170, the MS 1 113 can use the IP address allocated to the MS 1 113 when the MS 1 113 is located in cell 1 100. In contrast, even after moving into cell 1 100, the MS 1 113 can use the IP address allocated to the MS 1 113 when the MS 1 113 is located in cell 3 170. The use of the same address system between cells as described above enables an MS to continue using an IP address allocated in one cell even after moving between cells (e.g. between cell 1 100 and cell 3 170). A network constructed by the cells (e.g. between cell 1 100 and cell 3 170) using the same IP address is called the ‘same IP subnet’.

However, when MS 1 113 moves from cell 1 100 to cell 2 150 in FIG. 1, MS 1 113 is allocated IP addresses from different DHCP servers because BS 1 110 of cell 1 100 is connected to DHCP 1 190 and BS 2 140 of cell 2 150 is connected to DHCP 2 192. In this case, the IP address allocated by DHCP 1 190 when the MS 113 is located within cell 1 100 and the IP address allocated by DHCP 2 192 when the MS 113 is located within cell 2 150 have different prefix values. Therefore, the IP addresses allocated by DHCP 1 190 and the IP address allocated by DHCP 2 192 when the MS 113 moves from cell 1 100 to cell 2 150 have different prefix values. Therefore, the MS 113 cannot use the IP address allocated by DHCP 1 190 of cell 1 100 in cell 2 150. The cells using IP addresses having different prefix values constructs a different IP subnet. In other words, the same IP subnet refers to a network in which cells use IP addresses having the same prefix value, and in which an MS can use an IP address without change even when moving between cells. A different IP subnet refers to a network in which cells use IP addresses having different prefix value, and in which an MS must change the IP address when moving between cells.

Here, in order to perform handover to a neighbor cell, the MS must know information of neighbor cells (i.e. information of neighbor BSs). Therefore, the MS collects information of neighbor BSs by receiving periodic broadcast messages from the serving BS which currently provides service to the MS. In general, the message containing the information of neighbor BSs is referred to as a Mobile Neighbor Advertisement (MOB_NBR-ADV) message.

FIG. 2 is a table illustrating a structure of a typical MOB_NBR-ADV message.

The MOB_NBR-ADV message includes a plurality of Information Elements (IEs) such as ‘Management Message Type’ indicating the type of the transmitted message, ‘Configuration Change Count’ indicating the number of times by which the configuration changes, ‘N₁₃ Neighbors’ indicating the number of neighbor BSs, ‘Neighbor BS-ID’ indicating the number of identifiers of the neighbor BSs, ‘DL Physical Frequency’ indicating the physical channel frequency of the neighbor BS, and ‘TLV Encoded Neighbor Information’ indicating other information in relation to the neighbor BSs including Type, Length and Value (TLV).

The MOB_NBR-ADV message is periodically transmitted from the serving BS as described above and the MS can acquire scanning information for measuring the signal intensity of the neighbor BSs by receiving the MOB_NBR-ADV message. That is, the MS can identify neighbor BSs by using the field ‘Neighbor BS-ID’ and can recognize physical frequency band scan information necessary for scanning by using the field ‘DL Physical Frequency’. Further, the field ‘TLV Encoded Neighbor Information’ may include 16 bits of paging zone identifier (ID) information of corresponding neighbor BSs.

Now, the paging zone will be briefly discussed. In a communication system having a multi-cell structure, a plurality of neighbor cells may be constructed into one logical group (paging group) according to locations of the cells for paging of an MS. A Paging and Location Management (PLM) server (not shown) may provide a paging zone ID to each paging group as constructed above, so as to perform paging to multiple MSs located in the same paging zone. Then, the MSs located in the same paging zone confirms the paging zone ID in the field ‘TLV Encoded Neighbor Information’ of the MOB_NBR-ADV message, determines if the paging zone has been changed by comparing the paging zone ID of the currently received MOB_NBR-ADV message with the paging zone ID of the previously received MOB_NBR-ADV message, and then updates the location of the MS based on the determination. If an MS recognizes a change of the paging zone, it must perform a network re-entry process together with the corresponding BS of the changed paging zone. A more detailed description about location information update according to paging zone change of the MS will be given below with reference to FIG. 4.

FIG. 3 is a network re-entry process of an MS in a typical IEEE 802.16e communication system.

In step 311, according to handover, the MS acquires a system sync with a new serving BS to which the handover of the MS is performed by receiving a preamble of a downlink frame transmitted from the new serving BS. Then, the MS acquires a downlink sync by receiving BS information contained in various messages broadcasted by the BS, such as a Downlink Channel Descriptor (DCD) message, an Uplink Channel Descriptor (UCD) message, a DL_MAP message, a UL_MAP message and a MOB_NBR-ADV message.

In step 313, the MS transmits a ranging request (RNG_REQ) message to the BS and receives a ranging response (RNG_RSP) message from the BS as a response to the RNG_REQ message, thereby acquiring an uplink sync with the BS. In step 315, the MS adjusts the frequency and power.

In step 317, the MS negotiates with the BS for the basic capability of the MS. In step 319, the MS performs authentication with the BS, thereby acquiring a Traffic Encryption Key (TEK) allocated to the MS. In step 321, the MS requests registration of the MS itself to the BS and the BS performs the registration. In step 323, the MS performs an IP connection with the BS. The IP connection consumes a relatively long time interval of several seconds because it requires a handover process of the IP layer in which the DHCP server newly allocates an IP address and newly registers the location information.

In step 325, the MS downloads management information through an Internet protocol connected to the BS. In step 327, the MS performs a service flow connection with the BS. Here, the service flow refers to a flow by which MAC-Service Data Units (MAC-SDUs) are transmitted/received through a connection having a predetermined QoS. In step 329, the MS performs the service provided by the BS and then ends the process.

As described above, the IP connection (step 323) in the network re-entry process of the MS takes a relatively long time. However, if the BSs are located in the same IP subnet, the existing IP address can be used without change. Therefore, the IP connection as shown in step 323 (i.e. a process of allocating a new IP address) can be omitted. However, no specific scheme for achieving such omission has yet been defined in the current 802.16 specification.

FIG. 4 is a signal flow diagram for illustrating a process of updating location information of an MS in a conventional BWA communication system.

Before discussing FIG. 4, an idle mode and an awake mode will be described. The MAC layer of the BWA communication system supports two kinds of operation modes including an awake mode and a idle mode. First, the idle mode, or sleep mode has been proposed in order to minimize power consumption of the MS in an idle interval in which packet data transmission is not performed during at least a predetermined time interval. That is to say, when there is no packet data transmission, the MS transitions from the awake mode to the idle mode in order to minimize power consumption of the MS in the idle interval in which packet data are not transmitted. In general, the packet data are burst when generated. Therefore, it is unreasonable to perform the same operation in the interval in which packet data are not transmitted as that in the interval in which packet data are transmitted. For this reason, the idle mode has been proposed. In contrast, when packet data to be transmitted occur while the MS stays in the idle mode, the MS transits into the awake mode, or active mode and then transmits and receives the packet data. However, because the packet data has a property highly reliant on the traffic mode, the operation in the idle mode must be integrated in consideration of the traffic characteristics and transmission scheme characteristics of the packet data.

First, handover when the MS 410 in the idle mode moves between different paging zones (i.e. paging zone using different paging zone IDs) will be described with reference to FIG. 4. First, the serving BS 430 transmits a mobile idle response (MOB_DL_RSP) message to the MS 410 (step 411). Although FIG. 4 does not show any specific reason why the serving BS 430 transmits the MOB_IDL_RSP message to the MS 410, the serving BS 430 may transmit the MOB_IDL_RSP message either in response to a mobile idle request (MOB_IDL_REQ) message transmitted from the MS 410 to the serving BS 430 or in an unsolicited manner without any request. Upon receiving the MOB_IDL_RSP message from the serving BS 430, the MS 410 transitions from the awake mode into the idle mode.

Then, while the MS 410 is in the idle mode, the MS 410 moves from the service area controlled by the serving BS 430 to another service area controlled by another BS (target BS 450) different from the serving BS 430 (step 413). Here, it is assumed that the serving BS 430 and the target BS 450 are located in different paging zones. After the MS 410 moves as described above, the MS 410 has no connection for communication with the serving BS 430 and cannot receive a paging request (MOB_PAG_REQ) message even when the MS 410 wakes up at the paging time point and performs monitoring. Therefore, when the MS 410 detects the movement as described above, the MS 410 receives BS information through the DL_MAP message, the UL_MAP message, the DCD message and the UCD message broadcasted by the new BS after the movement, that is, the target BS 450 (step 415). As described above, the paging zone ID of the target BS 450 may be included in the DL_MAP message.

By receiving the BS information broadcasted by the target BS 450 as described above, the MS 410 recognizes the paging zone ID of the target BS 450 and thus recognizes that the serving BS 430 and the target BS 450 are located within different paging zones (step 417). When the MS 410 determines that the serving BS 430 and the target BS 450 are located within different paging zones, the MS 410 performs the initial ranging (step 419). By performing the initial ranging, the MS 410 acquires a basic Connection ID (CID) and a primary management CID. The MS 410 transmits a mobile station location update request (MOB_LU_REQ) message to the target BS 450 by using the primary CID previously acquired through the initial ranging (step 421). The MOB_LU_REQ message includes the paging zone ID stored in the MS 410 (the existing PZID).

Upon receiving the MOB_LU_REQ message from the MS 410, the target BS 450 transmits a location update request (LOCATION_UPDATE_REQUEST) message to a Paging and Location Management (PLM) server 470 (step 423). The LOCATION_UPDATE_REQUEST message includes a MAC address of the MS requesting the location information update and a paging zone ID of the serving BS 430 with which the MS belonged before the handover. Upon receiving the LOCATION_UPDATE_REQUEST message, the PLM server 470 updates the location of the MS 410 by referring to the paging zone ID and MAC address included in the LOCATION_UPDATE_REQUEST message, and transmits a location update response (LOCATION_UPDATE_RESPONSE) message to the target BS 450 as a response to the LOCATION_UPDATE_REQUEST message (step 425). Upon receiving the LOCATION_UPDATE_RESPONSE message from the PLM server 470, the target BS 450 transmits a location update response (MOB_LU_RSP) message to the MS 410 (step 427). After receiving the MOB_LU_RSP message from the target BS 450, the MS 410 performs mode transition into the idle mode in accordance with the selection calling period, etc. included in the MOB_LU_RSP message.

Hereinafter, problems of the conventional process for updating the location of an MS, as described above, will be discussed. After an MS moves into another paging zone in an idle mode, the MS periodically awakes and receives the MOB_NBR-ADV message transmitted from a BS. The MS compares a paging zone recognized by a currently received MOB_NBR-ADV message with a paging zone recognized by a previously received MOB_NBR-ADV message and performs location information update according to the result of the comparison. However, in performing the location information update of the MS as described above, if the MS moves into another paging zone directly after the period at which the MS awakes passes only one time, the MS cannot transition into the awake mode before the next period at which the MS awakes.

Also, in the conventional MOB_NBR-ADV message, information of neighbor BSs is arranged without any standard. In other words, in the conventional MOB_NBR-ADV message, the BS information recorded at the first order is not the information of the target BS having the highest priority and the BS information recorded at the final order is not the information of the target BS having the lowest priority. Therefore, the conventional MOB_NBR-ADV message includes only the information necessary for the scanning of neighbor BSs by the MS and does not include the information necessary for the MS's determination of the target BS to which the handover will be actually performed. It is also possible to use the TLV field for each neighbor BS in order to include paging zone ID of the neighbor BSs. However, because most of the BSs in the actual list belong to the same paging zone and have the same paging zone ID, the use of the TLV field for each BS may cause repetitive transmission of unnecessary information, thereby wasting resources of radio channels.

Further, according to the conventional process, even when the MS has moved between cells belonging to the same IP subnet, the MS must be allocated a new IP address. As a result, an unnecessarily long time delay occurs in the conventional network re-entry process of the MS. Therefore, it is necessary to define a new structure for the MOB_NBR-ADV message, which includes IP subnet information, but which does not include the 16 bits of paging zone ID since this information is overhead unnecessarily included in the TLV field of the conventional MOB_NBR-ADV message.

### SUMMARY OF THE INVENTION

Accordingly, the present invention has been made to solve the above-mentioned problems occurring in the prior art, and an object of the present invention is to propose a new broadcast message of a neighbor BS in a Broadband Wireless Access (BWA) communication system. It is another object of the present invention to provide a method for transmitting/receiving a newly proposed neighbor BS broadcast message in a BWA communication system. It is another object of the present invention to provide a method for fast network re-entry of an MS in a BWA communication system. It is another object of the present invention to provide a method for fast location information update according to location change of an MS in a BWA communication system.

In order to accomplish this object, a method is provided for transmitting and receiving information of neighbor base stations in a broadband wireless access communication system which includes a mobile station, a serving base station and the neighbor base stations located adjacent to the serving base station, the serving base station broadcasting information of the neighbor base stations to the mobile station. The method includes collecting the information of the neighbor base stations, determining if the collected information of the neighbor base stations is to the same as information of the serving base station, setting up predetermined groups by classifying the neighbor base stations according to a result of the determination, and broadcasting a predetermined message including information of the setup groups, respectively by the serving base station; and receiving the predetermined message broadcasted, confirming the information of the neighbor base stations included in the received message, and performing location information update in accordance with the confirmed information, respectively by the mobile station.

In accordance with another aspect of the present invention, a method is provided for constructing information of neighbor base stations by a serving base station in a broadband wireless access communication system which includes a mobile station, the serving base station and the neighbor base stations located adjacent to the serving base station, the serving base station broadcasting the information of the neighbor base stations to the mobile station. The method includes collecting the information of the neighbor base stations and determining if the collected information of the neighbor base stations is the same as the information of the serving base station; and setting up predetermined groups by classifying the neighbor base stations according to a result of the determination, and constructing a broadcasted message by combining the groups.

In accordance with another aspect of the present invention, is a method is provided for performing a location information update by a mobile station in a broadband wireless access communication system which includes the mobile station, a serving base station and neighbor base stations located adjacent to the serving base station, the serving base station broadcasting the information of the neighbor base stations to the mobile station. The method includes receiving information including paging zone identifiers identified by logical areas in order to page the mobile station and network address identifiers of the neighbor base stations from the serving base station; and confirming the information of the neighbor base stations included in the received information and performing location information update in accordance with the confirmed information.

In accordance with another aspect of the present invention, a system is provided for transmitting and receiving information of neighbor base stations in a broadband wireless access communication system which includes a mobile station, a serving base station and the neighbor base stations located adjacent to the serving base station, the serving base station broadcasting information of the neighbor base stations to the mobile station. The system includes the serving base station for collecting the information of the neighbor base stations, determining if the collected information of the neighbor base stations is to the same as information of the serving base station, setting up predetermined groups by classifying the neighbor base stations according to a result of the determination, and broadcasting a predetermined message including information of the setup groups; and the mobile station for receiving the predetermined message broadcasted, confirming the information of the neighbor base stations included in the received message, and performing location information update in accordance with the confirmed information.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram schematically showing the structure of a typical IEEE 802.16e communication system;

FIG. 2 is a table illustrating a structure of a typical MOB_NBR-ADV message;

FIG. 3 is a network re-entry process of an MS in a typical IEEE 802.16e communication system;

FIG. 4 is a signal flow diagram for illustrating a process of updating location information of an MS in a conventional BWA communication system;

FIG. 5 illustrates a table showing a structure of a MOB_NBR-ADV message proposed in a BWA communication system according to the present invention;

FIGS. 6A and 6B illustrate a flow diagram of a process in which a serving BS constructs a MOB_NBR-ADV message in a BWA communication system according to the present invention;

FIG. 7 is a flow diagram of an operational process of an MS after receiving the MOB_NBR-ADV message in a BWA communication system according to the present invention;

FIG. 8 is a signal flow diagram for illustrating a location information update process performed by an MS in a BWA communication system according to an embodiment of the present invention; and

FIG. 9 is a network re-entry process of an MS in a BWA communication system according to an embodiment of the present invention.

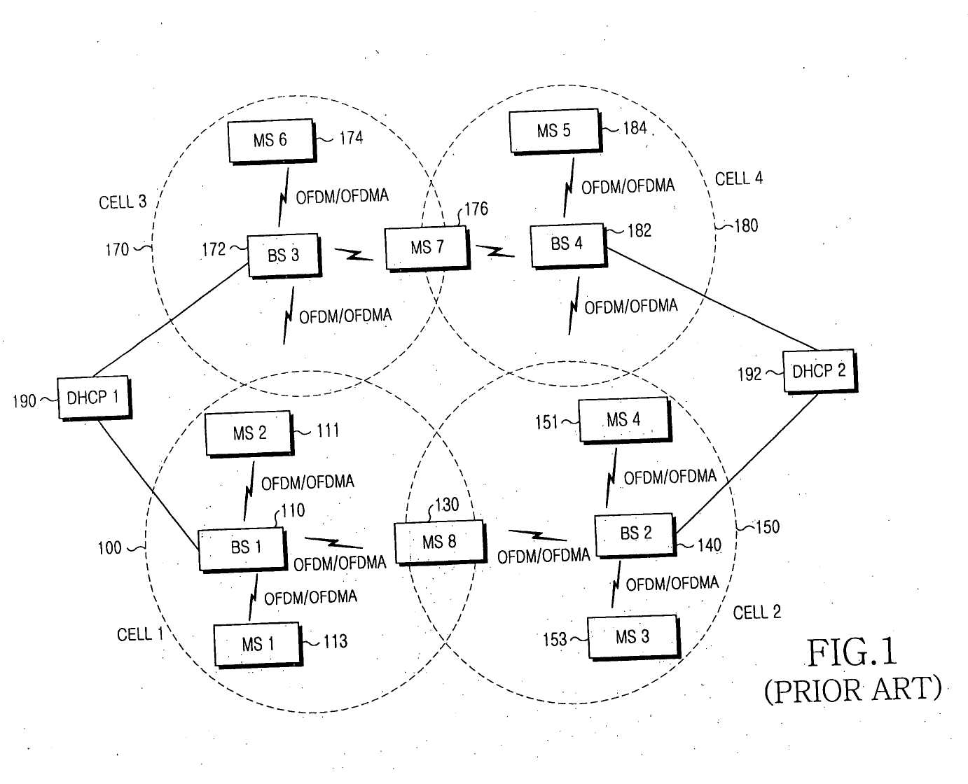

### DETAILED DESCRIPTION OF THE PREFERRED EMBODIMENT

Hereinafter, preferred embodiments of the present invention will be described with reference to the accompanying drawings. In the following description, a detailed description of known functions and configurations incorporated herein will be omitted when it may make the subject matter of the present invention unclear.

The present invention proposes a new format for the Mobile Neighbor Advertisement (MOB_NBR-ADV) message in a Broadband Wireless Access (BWA) communication system and proposes a method for message transmission/reception between a Base Station (BS) and a Mobile Station (MS) by using the proposed format.

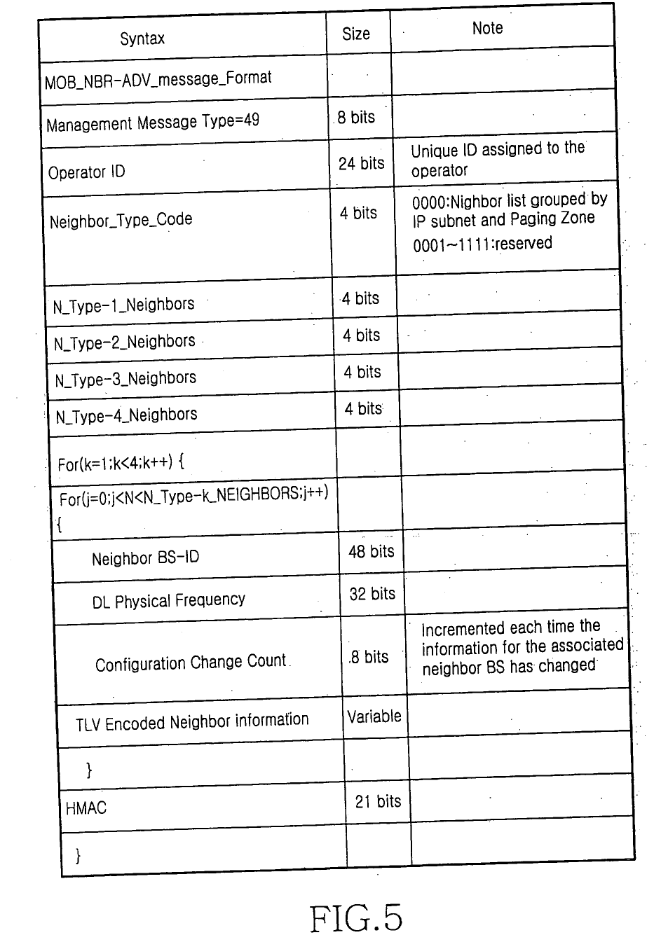

FIG. 5 illustrates a table showing a structure of a MOB_NBR-ADV message proposed in a BWA communication system according to the present invention.

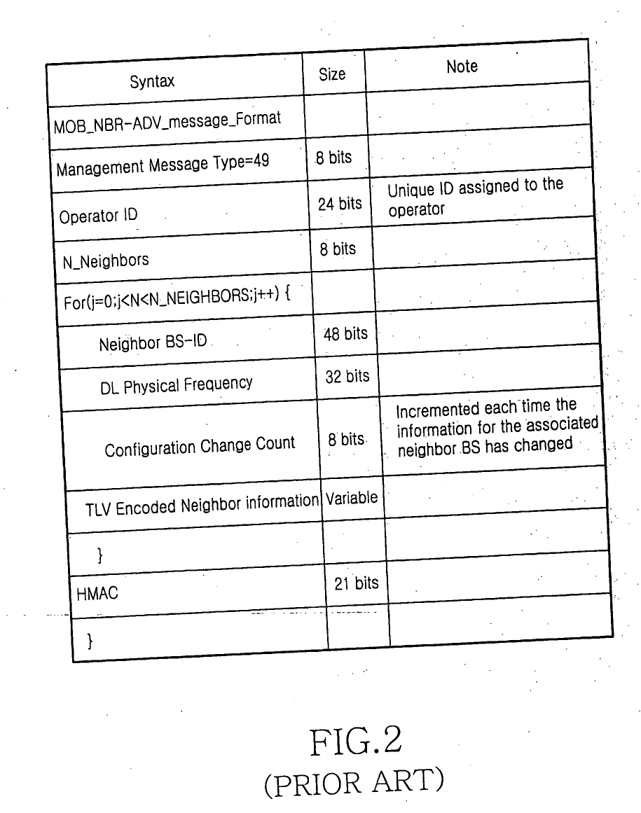

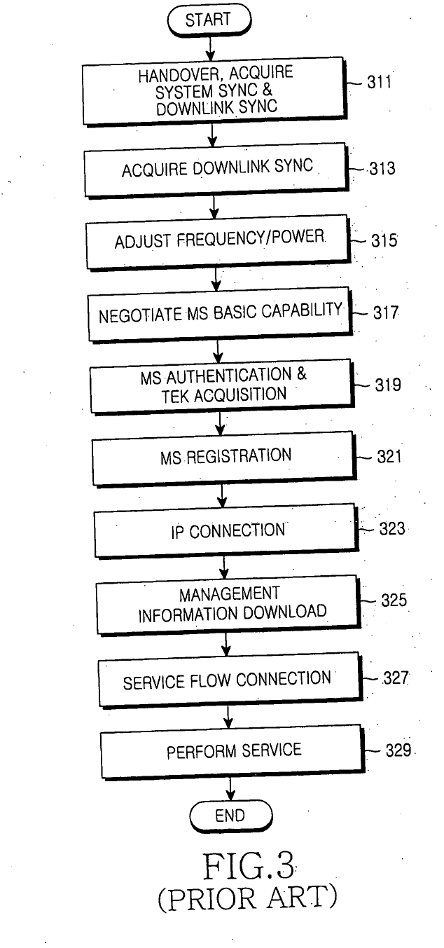

The MOB_NBR-ADV message includes fields of ‘Neighbor_Type_Code’, ‘N_Type-1_Neighbors’, ‘N_Type-2_Neighbors’, ‘N_Type-3_Neighbors’ and ‘N_Type-4_Neighbors’ in addition to the conventional structure thereof shown in FIG. 2.

Hereinafter, the fields of ‘Neighbor_Type_Code’, ‘N_Type-1_Neighbors’, ‘N_Type-2_Neighbors’, ‘N_Type-3_Neighbors’ and ‘N_Type-4_Neighbors’ will be described in detail.

First, the field of ‘Neighbor_Type_Code’ newly added to the MOB_NBR-ADV message indicates the meaning (or standard) by which the information of the BSs according to an embodiment of the present invention is classified, arranged and grouped. When the field of ‘Neighbor_Type_Code’ has a value of “0000”, the information of the BSs is classified, arranged and grouped according to whether the Internet Protocol (IP) subnet information and paging zone identifier (paging zone ID) of the neighbor BSs have changed or not. The preferred embodiment of the present invention, as described later, is based on an assumption that the field of ‘Neighbor_Type_Code’ has a value of “0000”.

Otherwise, when the information of the BSs is classified, arranged and grouped based on other information of the neighbor BSs instead of the IP subnet information and paging zone ID information of the neighbor BSs, the field of ‘Neighbor_Type_Code’ has a value between “0001” and “1111”. When the field of ‘Neighbor_Type_Code’ has a value between “0001” and “1111”, the field of ‘N_Type_Neighbor’ located after the field ‘Neighbor_Type_Code’ may be used in a more expanded manner. The field is used to store information of the neighbor BSs, other than the IP subnet information and paging zone ID information. Hereinafter, the case in which the field ‘Neighbor_Type_Code’ has a value of “0000”, that is, the case in which the IP subnet information and paging zone ID information from among the information of the neighbor BSs is used, will be described.

The fields of ‘N_Type-1_Neighbors’, ‘N_Type-2_Neighbors’, ‘N_Type-3_Neighbors’ and ‘N_Type-4_Neighbors’ newly added as is the field ‘Neighbor_Type_Code’ indicate information of neighbor BSs which are classified according to whether the IP subnet information and paging zone ID information of the neighbor BSs coincide with those of the current serving BS of the MS, when the field ‘Neighbor_Type_Code’ has a value of “0000”. These fields can be classified as follows.

‘N_Type-1_Neighbors’: BSs using the same IP subnet and the same paging zone ID as those of the serving BS.

‘N_Type-2_Neighbors’: BSs using the same IP subnet as that of the serving BS and a paging zone ID different from that of the serving BS.

‘N_Type-3_Neighbors’: BSs using an IP subnet different from that of the serving BS and the same paging zone ID as that of the serving BS.

‘N_Type-4_Neighbors’: BSs using an IP subnet and a paging zone ID different from those of the serving BS.

By receiving the MOB_NBR-ADV message broadcasted by the serving BS, the MS can understand in advance if the IP subnets and the paging zone ID of the neighbor BSs are the same or different from each other. As a result, when the MS moves, the MS can determine in advance whether to perform handover of the IP layer or update location information according to the change of the paging zone. That is, considering the fact that very long time delay is necessary until the handover of the higher IP layer is completed, the MS may try handover to a BS within the same IP subnet, thereby causing the handover of the higher IP layer in determining the target BS to which the handover will be performed. Further, when the MS in an idle mode moves between cells, the MS need not wait until the calling period or awake period and can determine whether to perform the IP connection reset or the paging zone location information update by comparing the received information with the stored neighbor BS information even in the idle mode.

According to the preferred embodiment of the present invention, the field ‘Neighbor_Type_Code’ has a value of “0000” and information of the neighbor BSs is classified, arranged and grouped according to coincidence of the IP subnet information and the paging zone ID information. Therefore, if the value of the field ‘Neighbor_Type_Code’ is defined in a way different from that in the preferred embodiment of the present invention, the fields of ‘N_Type_Neighbor’ also may have different meaning from that according to the preferred embodiment of the present invention.

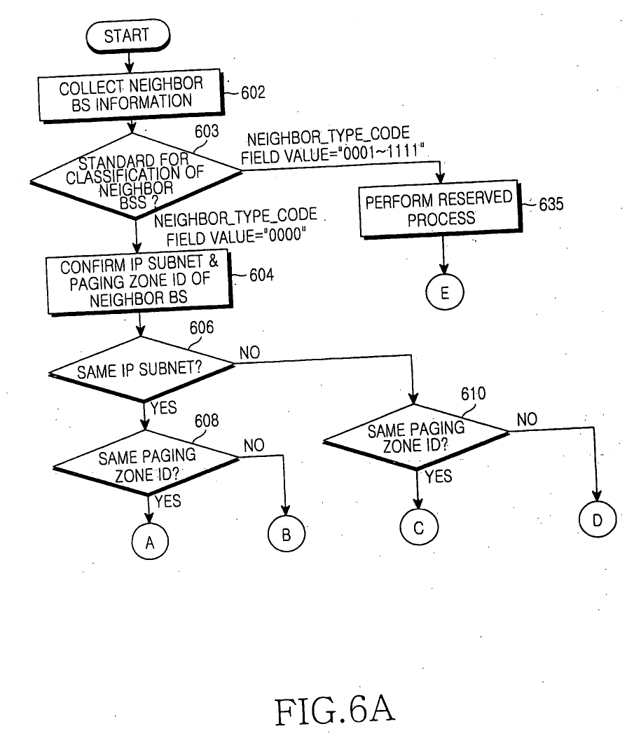

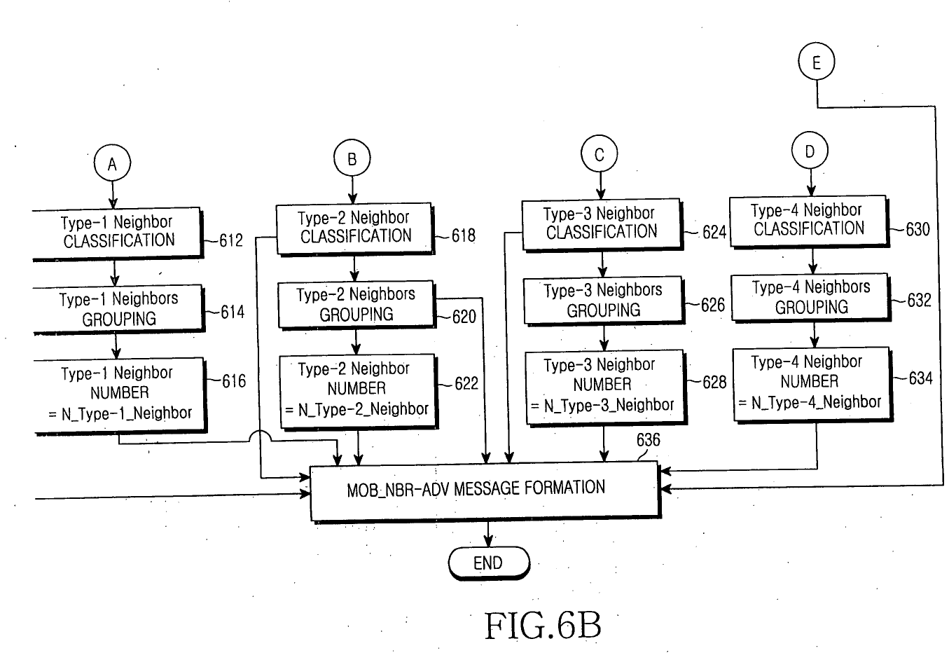

FIGS. 6A and 6B illustrate a flow diagram of a process in which a serving BS constructs a MOB_NBR-ADV message in a BWA communication system according to the present invention.

First, in step 602, the serving BS receives information of neighbor BSs from the neighbor BSs and stores the received information. In step 603, the serving BS selects and determines standard information from among the stored information of the neighbor BSs so as to use the standard information in classifying, arranging and grouping the neighbor BSs. That is, the serving BS determines the value of the field ‘Neighbor_Type_Code’ in step 603. When the classification is performed based on the IP subnet information and the paging zone ID information from among the information of the neighbor BSs, the value of the field ‘Neighbor_Type_Code’ is determined as “0000”, and step 604 is then performed. In contrast, when the classification is performed based on information of the neighbor BSs other than the IP subnet information and the paging zone ID information, the field ‘Neighbor_Type_Code’ is determined to have a value between “0001” and “1111”, and step 635 is then performed. In step 635, reserved processes are performed by using the information of the neighbor BSs other than the IP subnet information and the paging zone ID information. That is, classification and grouping of information is performed by using the information of the neighbor BSs other than the IP subnet information and the paging zone ID information. Step 636 is then performed.

In step 604, the serving BS confirms the IP subnet information and the paging zone ID information of the neighbor BSs from the stored information of the neighbor BSs. Thereafter, the serving BS sequentially determines if the IP subnet and paging zone ID of the serving BS are equal to the confirmed IP subnet and paging zone ID of each neighbor BS. In step 606, the serving BS determines if the IP subnet of the serving BS is equal to the confirmed IP subnet of a predetermined neighbor BS (hereinafter, referred to as “first neighbor BS”). When the IP subnet of the serving BS is equal to the confirmed IP subnet of the first neighbor BS, the serving BS proceeds to step 608. In step 608, the serving BS determines if the paging zone ID of the serving BS is equal to the confirmed paging zone ID of the first neighbor BS. When the paging zone ID of the serving BS is equal to the confirmed paging zone ID of the first neighbor BS, the serving BS proceeds to step 612.

In step 612, the serving BS classifies the first neighbor BS as Type-1 Neighbor. Then, in step 614, the serving BS inserts the first neighbor BS in the group of Type-1 Neighbors. In step 616, the serving BS increases the number of Type-1 Neighbors by ‘1’, that is, the serving BS updates the number of Type-1 Neighbors by adding one to the number and proceeds to step 636. In step 636, the serving BS constructs the MOB_NBR-ADV message by setting the number of neighbor BSs classified as Type-1 Neighbor in the field ‘N_Type-1 Neighbors’ of the MOB_NBR-ADV message.

When the IP subnet of the serving BS is same to the confirmed IP subnet of the first neighbor BS but the paging zone ID of the serving BS is different from the confirmed paging zone ID of the first neighbor BS by the determination in step 608, the serving BS proceeds to step 618. In step 618, the serving BS classifies the first neighbor BS as Type-2 Neighbor. Then, in step 620, the serving BS inserts the first neighbor BS in the group of Type-2 Neighbors. In step 622, the serving BS increases the number of Type-2 Neighbors by ‘1’, that is, the serving BS updates the number of Type-2 Neighbors by adding one to the number and proceeds to step 636. In step 636, the serving BS constructs the MOB_NBR-ADV message by setting the number of neighbor BSs classified as Type-2 Neighbor in the field ‘N_Type-2 Neighbors’ of the MOB_NBR-ADV message.

The above description deals with a process of setting the field values of N_Type-1 Neighbor and N_Type-2 Neighbor between the serving BS and the first neighbor BS, and a process of setting the field values of N_Type-3 Neighbor and N_Type-4 Neighbor between the serving BS and the first neighbor BS will be described below.

When the IP subnet of the serving BS is different from the confirmed IP subnet of the first neighbor BS by the determination in step 606, the serving BS proceeds to step 610. In step 610, the serving BS determines if the paging zone ID of the serving BS is equal to the confirmed paging zone ID of the first neighbor BS. When the paging zone ID of the serving BS is equal to the confirmed paging zone ID of the first neighbor BS, the serving BS proceeds to step 624. In step 624, the serving BS classifies the first neighbor BS as Type-3 Neighbor. Then, in step 626, the serving BS inserts the first neighbor BS in the group of Type-3 Neighbors. In step 628, the serving BS increases the number of Type-3 Neighbors by ‘1’, that is, the serving BS updates the number of Type-3 Neighbors by adding one to the number and proceeds to step 636. In step 636, the serving BS constructs the MOB_NBR-ADV message by setting the number of neighbor BSs classified as Type-3 Neighbor in the field ‘N_Type-3 Neighbors’ of the MOB_NBR-ADV message.

When the paging zone ID of the serving BS is different from the confirmed paging zone ID of the first neighbor BS by the determination in step 610, the serving BS proceeds to step 630. In step 630, the serving BS classifies the first neighbor BS as Type-4 Neighbor. Then, in step 632, the serving BS inserts the first neighbor BS in the group of Type-4 Neighbors. In step 634, the serving BS increases the number of Type-4 Neighbors by ‘1’; that is, the serving BS updates the number of Type-4 Neighbors by adding one to the number and proceeds to step 636. In step 636, the serving BS constructs the MOB_NBR-ADV message by setting the number of neighbor BSs classified as Type-4 Neighbor in the field ‘N_Type-4 Neighbors’ of the MOB_NBR-ADV message.

After completing the classification of the first neighbor BS in the way described above, the serving BS sequentially performs the above-described process again for each of the remaining neighbor BSs, thereby constructing the MOB_NBR-ADV message by setting each field thereof. Then, the serving BS broadcasts the MOB_NBR-ADV message.

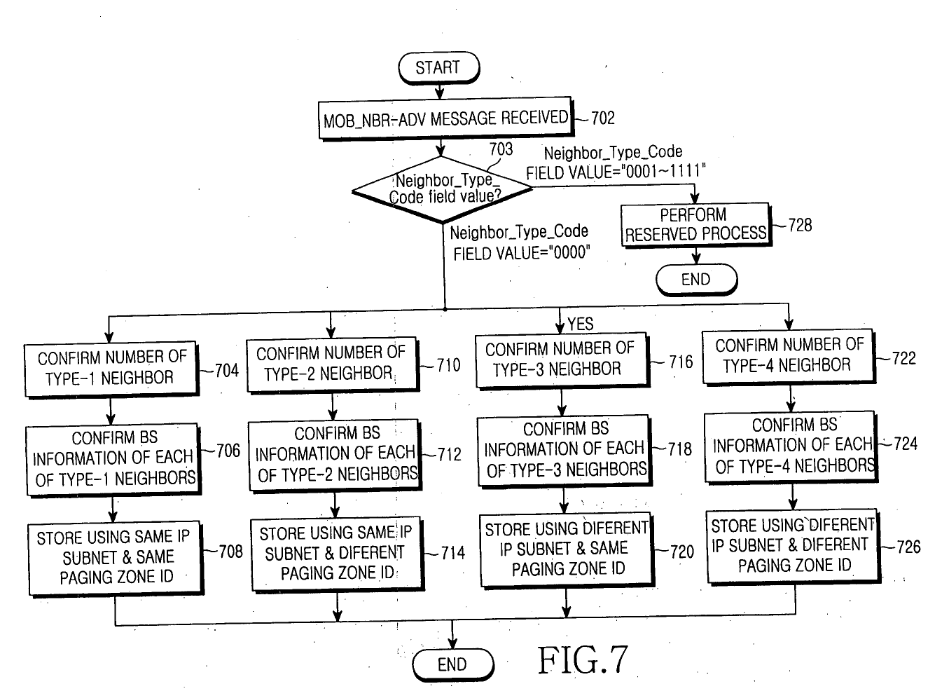

FIG. 7 is a flow diagram of an operation process of an MS after receiving the MOB_NBR-ADV message in a BWA communication system according to the present invention.

In step 702, the MS receives the MOB_NBR-ADV message broadcasted by the serving BS. In step 703, the MS confirms the value of the field “Neighbor_Type_Code’ of the received MOB_NBR-ADV message. When the confirmed value of the field “Neighbor_Type_Code’ is “0000” as in the embodiment shown in FIGS. 5, 6A and 6B, it is noted that the information of Type-N Neighbors is classified, arranged and grouped based on the IP subnet information and paging zone ID information. When the field “Neighbor_Type_Code’ has a value of “0000” as described above, the MS proceeds to step 704, step 710, step 716 or step 722. Meanwhile, when the field “Neighbor_Type_Code’ has a value between “0001” and “1111”, it is noted that the information of Type-N Neighbors is classified, arranged and grouped based on information other than the IP subnet information and paging zone ID information. When the field “Neighbor_Type_Code’ has a value between “0001” and “111138 , the MS proceeds to step 728 and performs a reserved process. That is, in step 728, the MS confirms the information of the neighbor BSs included in the received MOB_NBR-ADV message.

After the MS proceeds to step 704, step 710, step 716 or step 722, the MS reads the value set in each field of the MOB_NBR-ADV message in order to understand the neighbor BS information. Specifically, in step 704, the MS confirms the number of neighbor BSs classified as Type-1 Neighbor and set in the filed ‘N_Type-1 Neighbors’ of the MOB_NBR-ADV message. Then, in step 706, the MS confirms the BS information of each of the neighbor BSs the number of which has been confirmed. In step 708, the MS recognizes to use the same IP subnet and the same paging zone ID of the confirmed neighbor BSs and stores the informations.

In step 710, the MS confirms the number of neighbor BSs classified as Type-2 Neighbor and set in the filed ‘N_Type-2 Neighbors’ of the MOB_NBR-ADV message. Then, in step 712, the MS confirms the BS information of each of the neighbor BSs the number of which has been confirmed. In step 714, the MS recognizes to use the same IP subnet and the different paging zone ID of the confirmed neighbor BSs and stores the informations.

In step 716, the MS confirms the number of neighbor BSs classified as Type-3 Neighbor and set in the filed ‘N_Type-3 Neighbors’ of the MOB_NBR-ADV message. Then, in step 718, the MS confirms the BS information of each of the neighbor BSs the number of which has been confirmed. In step 720, the MS recognizes to use the different IP subnet and the same paging zone ID of the confirmed neighbor BSs and stores the informations.

In step 722, the MS confirms the number of neighbor BSs classified as Type-4 Neighbor and set in the filed ‘N_Type-4 Neighbors’ of the MOB_NBR-ADV message. Then, in step 724, the MS confirms the BS information of each of the neighbor BSs the number of which has been confirmed. In step 726, the MS recognizes to use the different IP subnet and the different paging zone ID of the confirmed neighbor BSs and stores the informations.

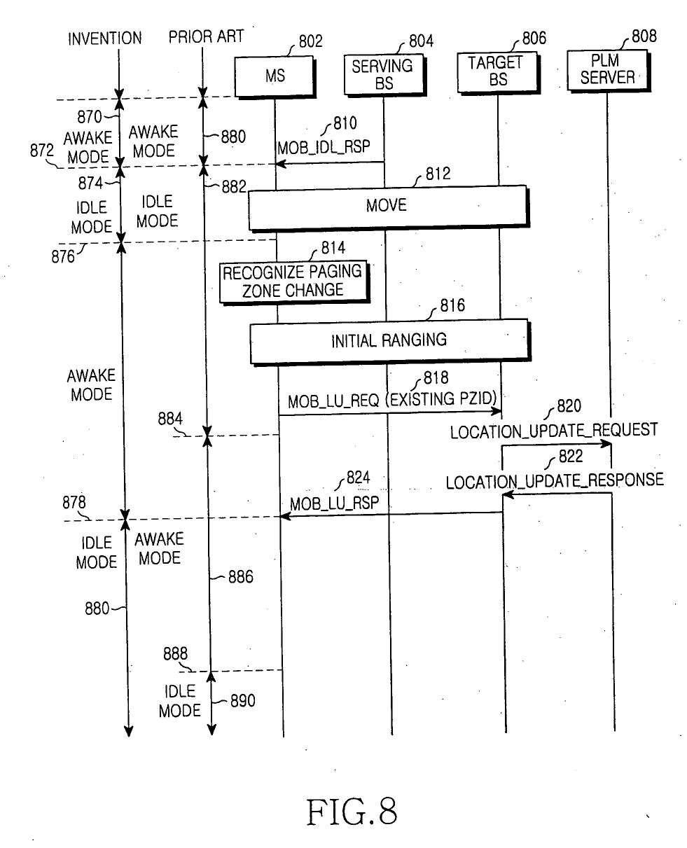

FIG. 8 is a signal flow diagram for illustrating a location information update process performed by an MS in a BWA communication system according to an embodiment of the present invention. FIG. 8 also provides comparison of the relative timing for common events in the location information update process under the prior art system and the present invention.

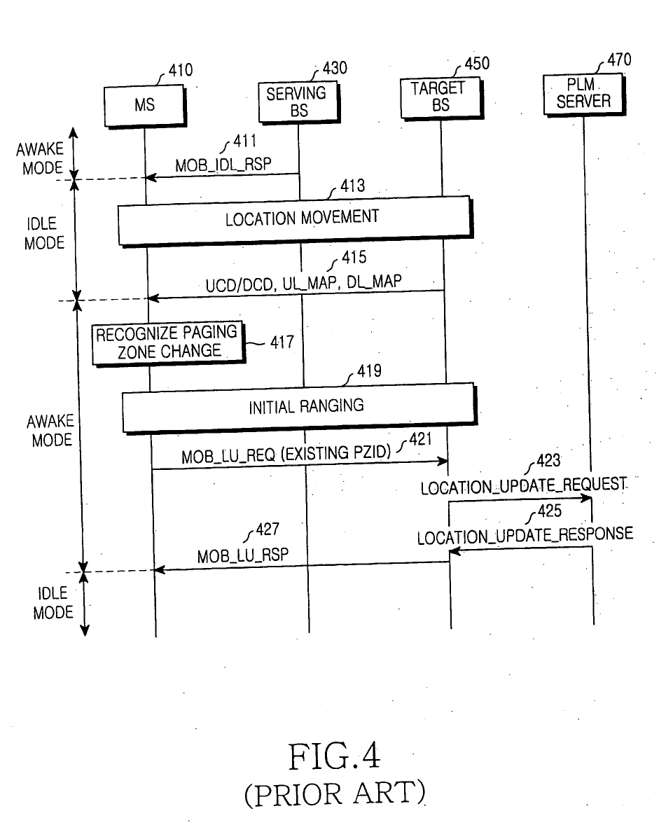

By comparing FIG. 8 with FIG. 4, it is noted that the MOB_NBR-ADV message newly proposed by the present invention can reduce the time for update of location information according to the MS's change of the paging zone. Referring to FIG. 8, first, when an MS 802 in an awake mode 870 receives a mobile idle response (MOB_IDL_RSP) message from a serving BS 804 (step 810), the MS transfers into the idle mode 874 at the time point 872. Although FIG. 8 does not show any specific reason why the serving BS 804 transmits the MOB_IDL_RSP message to the MS 802, the serving BS 804 may transmit the MOB_IDL_RSP message either in response to a mobile idle request (MOB_IDL_REQ) message transmitted from the MS 802 to the serving BS 804 or in an unsolicited manner without any request.

While the MS 802 is in the idle mode, the MS 802 may move from the service area controlled by the serving BS 804 to another service area controlled by target BS 806 (step 812). In this case, according to the conventional method, although the MS 802 has actually changed its location, the MS 802 cannot understand the change of its paging zone because it is in the idle mode. That is to say, the MS 802 in the idle mode 882 transitions into the awake mode 886 only from the time point 884 which is the time point at which it is scheduled to end the idle mode. The MS 802 can recognize the difference between the paging zone ID of the serving BS 804 and the paging zone ID of the target BS 806 only after directly receiving the information of the target BS through the UCD/DCD message, the UL_MAP message, the DL_MAP message, etc. as in step 415 of FIG. 4.

However, according to the present invention, after the MS 802 moves to the target BS 806 (step 812), the MS 802 already understands (through the process shown in FIG. 7. from the MOB_NBR-ADV message received by the MS 802 from the serving BS 804) whether the paging ID of the target BS 806 is equal to the paging ID of the serving BS 804. Therefore, in step 814, the MS 802 understands that the paging ID of the target BS 806 is different from the paging ID of the serving BS 804. Specifically, the MS 802 measures the signal level (e.g. the CINR of the pilot signal) by using the pilot signal which it received from the BS in the idle mode 874 and recognizes its movement into another cell when there is change in the signal level. Therefore, the MS 802 recognizes a BS corresponding to a signal level having the largest value as a current serving BS to which the MS 802 currently belongs and obtains information of the BS from the information stored in advance. After recognizing the change of the paging zone in step 814, the MS 802 performs the initial ranging together with the target BS 806 (step 816) and then performs a process of location information update.

That is, by performing the initial ranging in step 816, the MS 802 acquires a basic Connection ID (CID) and a primary management CID. The MS 802 transmits a mobile station location update request (MOB_LU_REQ) message to the target BS 806 by using the primary CID acquired through the initial ranging (step 818). The MOB_LU_REQ message includes the paging zone ID stored in the MS 802 (the existing PZID).

Upon receiving the MOB_LU_REQ message from the MS 802, the target BS 806 transmits a location update request (LOCATION_UPDATE_REQUEST) message to a Paging and Location Management (PLM) server 808 (step 820). The LOCATION_UPDATE_REQUEST message includes a MAC address of the MS requesting the location information update and a paging zone ID of the serving BS 804 to which the MS 802 belonged before the handover. Upon receiving the LOCATION_UPDATE_REQUEST message, the PLM server 808 updates the location of the MS 802 by referring to the paging zone ID and MAC address included in the LOCATION_UPDATE_REQUEST message, and transmits a location update response (LOCATION_UPDATE_RESPONSE) message to the target BS 806 as a response to the LOCATION_UPDATE_REQUEST message (step 822). Upon receiving the LOCATION_UPDATE_RESPONSE message from the PLM server 808, the target BS 806 transmits a location update response (MOB_LU_RSP) message to the MS 802 (step 824). After receiving the MOB_LU_RSP message from the target BS 806, the MS 802 performs mode transition into the idle mode 880 at the time point 878 in accordance with the selection calling period, etc. included in the MOB_LU_RSP message.

Now, FIG. 8, illustrating a process of the present invention, will be briefly compared with FIG. 4, illustrating the conventional process. According to the present invention, the MS 802 performs the location information update process in a state which has already recognized the change of the paging zone in step 818. However, according to the conventional process, the MS 802 still stays in the idle mode 882. Therefore, the new MOB_NBR-ADV message proposed by the present invention enables the MS to acquire information of neighbor BSs in advance, so that the location information update can be performed without a long time delay, even when the paging zone changes as shown in FIG. 8. Therefore, the present invention achieves faster location information update in comparison with the conventional technology.

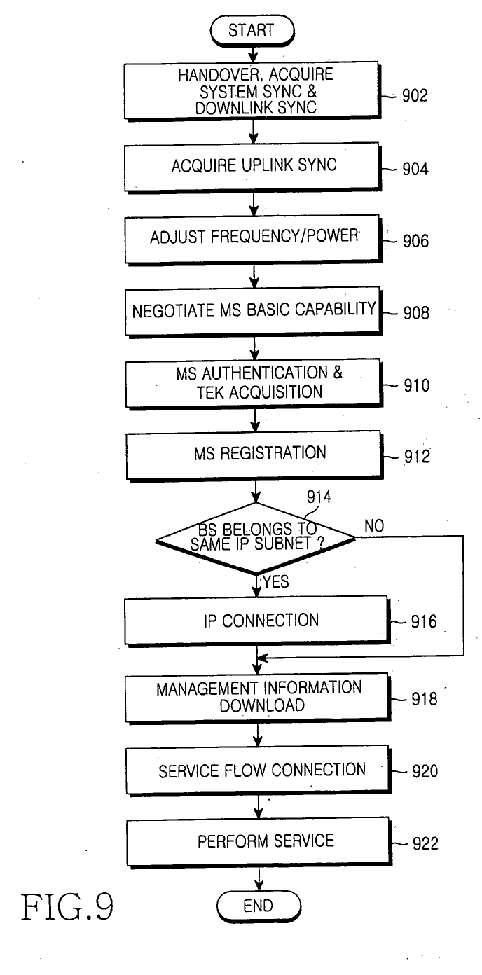

FIG. 9 is a network re-entry process of an MS in a BWA communication system according to an embodiment of the present invention.

In step 902, according to handover, the MS acquires a system sync with a new serving BS to which the handover of the MS is performed by receiving a preamble of a downlink frame transmitted from the new serving BS. Then, the MS acquires a downlink sync by receiving BS information contained in various messages broadcasted by the BS, such as a Downlink Channel Descriptor (DCD) message, an Uplink Channel Descriptor (UCD) message, a DL_MAP message, a UL_MAP message and a MOB_NBR-ADV message.

In step 904, the MS transmits a ranging request (RNG_REQ) message to the BS and receives a ranging response (RNG_RSP) message from the BS as a response to the RNG_REQ message, thereby acquiring an uplink sync with the BS. In step 906, the MS adjusts the frequency and power.

In step 908, the MS negotiates with the BS for the basic capability of the MS. In step 910, the MS performs authentication with the BS, thereby acquiring a Traffic Encryption Key (TEK) allocated to the MS. In step 912, the MS requests its registration with the BS and the BS performs the registration. In step 914, the MS determines by using the neighbor BS information acquired from the received MOB_NBR-ADV message if the target BS uses the same IP subnet as that of the previous serving BS. As a result of the determination, when the two BSs use the same IP subnet, the MS need not be allocated a new IP address and thus proceeds to step 918 without performing step 916. However, when the two BSs use different IP subnet, the MS must be allocated a new IP address and thus proceeds to step 916 in order to be allocated the new IP address.

In step 916, the MS performs an IP connection with the BS. In step 918, the MS downloads management information through an Internet protocol connected to the BS. In step 920, the MS performs a service flow connection with the BS. The service flow refers to a flow by which MAC-Service Data Units (MAC-SDUs) are transmitted and received through a connection having a predetermined QoS. In step 922, the MS performs the service provided by the BS and then ends the process.

According to the present invention as described above, the serving BS collects information of neighbor BSs including the IP subnet and paging zone ID information, constructs a MOB_NBR-ADV message based on the IP subnet and paging zone ID information, and periodically broadcasts the constructed MOB_NBR-ADV message. The MS stores the information of the neighbor BSs by receiving the MOB_NBR-ADV message. Therefore, according to the present invention, the process of IP connection can be omitted from the handover process between cells using the same IP subnet in the network re-entry process of the MS, so that fast handover can be achieved. Further, according to the present invention, when the MS moves between paging zones in an idle mode, the MS can achieve faster location information update.

While the invention has been shown and described with reference to certain preferred embodiments thereof, it will be understood by those skilled in the art that various changes in form and details may be made therein without departing from the spirit and scope of the invention as defined by the appended claims.

1. A method for transmitting and receiving information of neighbor base stations in a broadband wireless access communication system which includes a mobile station, a serving base station and the neighbor base stations located adjacent to the serving base station, the serving base station broadcasting information of the neighbor base stations to the mobile station, the method comprising the steps of:
collecting the information of the neighbor base stations, determining if the collected information of the neighbor base stations is the same as information of the serving base station, setting up predetermined groups by classifying the neighbor base stations according to a result of the determination, and broadcasting a predetermined message including information of the setup groups, respectively by the serving base station; and
receiving the predetermined message broadcasted, confirming the information of the neighbor base stations included in the received message, and performing location information update in accordance with the confirmed information, respectively by the mobile station.

2. The method as claimed in claim 1, wherein, in the step of setting up predetermined groups, the predetermined groups are set up with reference to at least one piece of information from among the information of the neighbor base stations classified in accordance with paging zone identifiers identified by logical areas in order to page the mobile station, and in accordance with network address identifiers of the neighbor base stations.

3. The method as claimed in claim 2, wherein, in the step of setting up predetermined groups,
the neighbor base stations are set up as a first group when the neighbor base stations and the serving base station have the same network address identifier and the same paging zone identifier;
the neighbor base stations are set up as a second group when the neighbor base station and the serving base station have the same network address identifier and different paging zone identifiers;
the neighbor base stations are set up as a third group when the neighbor base station and the serving base station have different network address identifiers and the same paging zone identifier; and
the neighbor base stations are set up as a fourth group when the neighbor base station and the serving base station have different network address identifiers and different paging zone identifiers.

4. The method as claimed in claim 1, wherein the step of confirming the information of the neighbor base stations comprises the steps of:
confirming information of the groups of the neighbor base stations included in the received message;
confirming a number of the neighbor base stations included in each of the groups; and
confirming information of each of the neighbor base stations, the number of which has been confirmed.

5. The method as claimed in claim 1, wherein the step of performing location information update comprises the steps of:
storing the information of the confirmed neighbor base stations;
transmitting a message requesting the location information update at a predetermined time point at which the information has been stored;
receiving a location update response message in response to the message requesting the location information update; and
updating location information in accordance with the information of the neighbor base stations when the location update response message has been received.

6. A method for constructing information of neighbor base stations by a serving base station in a broadband wireless access communication system which includes a mobile station, the serving base station and the neighbor base stations located adjacent to the serving base station, the serving base station broadcasting the information of the neighbor base stations to the mobile station, the method comprising the steps of:
collecting the information of the neighbor base stations and determining if the collected information of the neighbor base stations is the same as the information of the serving base station; and
setting up predetermined groups by classifying the neighbor base stations according to a result of the determination, and constructing a broadcasted message by combining the groups.

7. The method as claimed in claim 6, wherein, in the step of setting up predetermined groups, the predetermined groups are set up with reference to at least one piece of information from among the information of the neighbor base stations classified in accordance with paging zone identifiers identified by logical areas in order to page the mobile station, and in accordance with network address identifiers of the neighbor base stations.

8. The method as claimed in claim 7, wherein, in the step of setting up predetermined groups,
the neighbor base stations are set up as a first group when the neighbor base stations and the serving base station have the same network address identifier and the same paging zone identifier;
the neighbor base stations are set up as a second group when the neighbor base station and the serving base station have the same network address identifier and different paging zone identifiers;
the neighbor base stations are set up as a third group when the neighbor base station and the serving base station have different network address identifiers and the same paging zone identifier; and
the neighbor base stations are set up as a fourth group when the neighbor base station and the serving base station have different network address identifiers and different paging zone identifiers.

9. A method for performing location information update by a mobile station in a broadband wireless access communication system which includes the mobile station, a serving base station and neighbor base stations located adjacent to the serving base station, the serving base station broadcasting the information of the neighbor base stations to the mobile station, the method comprising the steps of:
receiving information including paging zone identifiers identified by logical areas in order to page the mobile station, and including network address identifiers of the neighbor base stations from the serving base station; and
confirming the information of the neighbor base stations included in the received information and performing location information update in accordance with the confirmed information.

10. The method as claimed in claim 9, wherein the step of performing location information update comprises the steps of:
storing the information of the confirmed neighbor base stations;
transmitting a message requesting the location information update at a predetermined time point at which the information has been stored;
receiving a location update response message in response to the message requesting the location information update; and
updating location information in accordance with the information of the neighbor base stations when the location update response message has been received.

11. The method as claimed in claim 9, wherein the step of performing location information update comprises the steps of:
storing the information of the confirmed neighbor base stations;
measuring a level of a signal which is transmitted from the serving base station and received by the mobile station and storing the information in an idle mode;
transmitting a message requesting the location information update when a change in intensity of the signal is detected from the measurement;
receiving a location update response message in response to the message requesting the location information update; and
updating location information in accordance with the information of the neighbor base stations when the location update response message has been received.

12. A system for transmitting and receiving information of neighbor base stations in a broadband wireless access communication system which includes a mobile station, a serving base station and the neighbor base stations located adjacent to the serving base station, the serving base station broadcasting information of the neighbor base stations to the mobile station, the system comprising:
the serving base station for collecting the information of the neighbor base stations, determining if the collected information of the neighbor base stations is the same as information of the serving base station, setting up predetermined groups by classifying the neighbor base stations according to a result of the determination, and broadcasting a predetermined message including information of the setup groups; and
the mobile station for receiving the predetermined message broadcasted, confirming the information of the neighbor base stations included in the received message, and performing location information update in accordance with the confirmed information.

13. The system as claimed in claim 12, wherein the serving base station sets up the predetermined groups by referring to at least one piece of information from among the information of the neighbor base stations classified in accordance with paging zone identifiers identified by logical areas in order to page the mobile station, and in accordance with network address identifiers of the neighbor base stations.

14. The system as claimed in claim 13, wherein, when the serving base station sets up the predetermined groups,
the neighbor base stations are set up as a first group when the neighbor base stations and the serving base station have the same network address identifier and the same paging zone identifier;
the neighbor base stations are set up as a second group when the neighbor base station and the serving base station have the same network address identifier and different paging zone identifiers;
the neighbor base stations are set up as a third group when the neighbor base station and the serving base station have different network address identifiers and the same paging zone identifier; and
the neighbor base stations are set up as a fourth group when the neighbor base station and the serving base station have different network address identifiers and different paging zone identifiers.

15. The system as claimed in claim 12, wherein the mobile station confirms information of the groups of the neighbor base stations included in the received message, a number of the neighbor base stations included in each of the groups, and information of each of the neighbor base stations the number of which has been confirmed.

16. The system as claimed in claim 12, wherein the mobile station stores the information of the confirmed neighbor base stations, transmits a message requesting the location information update at a predetermined time point at which the information has been stored, receives a location update response message in response to the message requesting the location information update, and updates location information in accordance with the information of the neighbor base stations when the location update response message has been received.
